(19) United States
(12) Patent Application Publication
(10) Pub. No.: US 2006/0049801 A1
(43) Pub. Date: Mar. 9, 2006

(54) Electronic apparatus with remote controller

(75) Inventor: Hiroyuki Miyazaki, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/216,161

(22) Filed: Sep. 1, 2005

(30) Foreign Application Priority Data
Sep. 6, 2004 (JP) 2004-258731

(51) Int. Cl. H02J 7/00

(52) U.S. Cl. 320/132

(57) ABSTRACT

To provide an electronic apparatus with a remote controller, in which the remote controller can transmits the residual capacity of a battery used therein to the electronic apparatus, and the electronic apparatus can indicate the residual battery capacity so that a user can recognize the residual battery capacity with reliability. In a remote controller 1, a voltage detecting section 3 detects the voltage of a battery, and a remote-controller microcomputer 4 converts the detected battery voltage into a code value representing a classified level of battery voltage and transmits the code value. An electronic apparatus 11 has a main-unit microcomputer 14 for converting the code value into a corresponding residual battery capacity and indicates the residual battery capacity through visible or sound means.

The present application is based on and claims priority of Japanese patent application No. 2004-258731 filed on Sep. 6, 2004, the entire contents of which are hereby incorporated by reference.

### BACKGROUND OF THE INVENTION

1. Field of the Invention

The present invention relates to a technique that allows a remote controller to transmit the residual capacity of a battery used therein to an associated electronic apparatus and the electronic apparatus to inform a user of the residual capacity through display or other operation.

2. Description of the Related Art

As a method of allowing an electronic apparatus to display the residual capacity of a battery contained in an associated remote controller, there has been proposed a prior-art technique described below, for example. According to a method proposed in Japanese Patent Publication No. 7-250391 (Patent Document 1), a remote controller transmits a signal to a main unit at regular intervals, and the main unit informs a user that an abnormality occurs when the transmission of the regular signals is interrupted, for example, when the battery in the remote controller runs down and the main unit can no longer receive any regular signals, or when the remote controller moves too far away from the main unit and any regular signals can no longer reach the main unit, so that the user can readily realize that the main unit cannot be activated with the remote controller.

The prior-art technique disclosed in the Patent Document 1 has a problem that the battery runs down quickly because the remote controller transmits signals at regular intervals regardless of whether the user manipulates the controller or not. In addition, except when the user is manipulating the main unit, the remote controller may not be aimed at the main unit. In such a case, the main unit informs the user of the occurrence of an abnormality as in the case where no regular signal can reach the main unit, and thus, the user erroneously realizes that the main unit cannot be activated.

### SUMMARY OF THE INVENTION

An object of the present invention is to provide an electronic apparatus with a remote controller, in which the residual capacity of a battery used in the remoter controller is classified into plural levels, the remote controller transmits the classified level of residual capacity of the battery to the electronic apparatus, informing means in the electronic apparatus enables recognition of the level of residual capacity of the battery, and detection and information of the residual battery capacity are carried out when a remote-controller manipulation key is first or last manipulated during use of the electronic apparatus, so that battery exhaustion due to regular signal transmission can be suppressed, and the user can be informed of the residual battery capacity with reliability when the electronic apparatus is activated or terminated.

An electronic apparatus with a remote controller as set forth in a first aspect is an electronic apparatus with a remote controller, the remote controller including power supply means constituted by a battery, remote manipulation means that transmits an instruction signal corresponding to an instruction entered through manipulation of a manipulation key, thereby remotely manipulating the electronic apparatus, detection means that detects the voltage of the battery, and transmission means that converts the detected battery voltage into a code value and transmits the code value, in which the transmission means converts the detected battery voltage into a code value, which is assigned to a classified level of voltage value of the detected battery voltage, and the electronic apparatus comprises code value converting means that converts the code value transmitted from the remote controller into a corresponding residual battery capacity value and residual battery capacity informing means that indicates the residual battery capacity converted from the code value by the code value converting means.

According to the configuration as set forth in a first aspect, since the remote controller comprises power supply means constituted by a battery, remote manipulation means that transmits an instruction signal corresponding to an instruction entered through manipulation of a manipulation key, thereby remotely manipulating the electronic apparatus, detection means that detects the voltage of the battery in the remote controller, and transmission means that converts the detected battery voltage into a code value and transmits the code value, and the transmission means converts the detected battery voltage into a code value, which is assigned to a classified level of voltage value of the detected battery voltage, the remote controller can transmit information about the current level of the detected battery voltage to the electronic apparatus in the form of a code value. In addition, since the electronic apparatus comprises code value converting means that converts the code value transmitted from the remote controller into a corresponding residual battery capacity value and residual battery capacity informing means that indicates the residual battery capacity converted from the code value by the code value converting means, the electronic apparatus can inform the user of the level of residual capacity of the battery in the remote controller.

An electronic apparatus with a remote controller as set forth in a second aspect is the electronic apparatus with a remote controller as set forth in a first aspect, in which the residual battery capacity informing means visibly indicates the residual battery capacity on a display section of the electronic apparatus.

According to the configuration as set forth in a second aspect, since the residual battery capacity informing means visibly indicates the residual battery capacity on a display section of the electronic apparatus, the user can recognize the level of residual capacity of the battery in the remote controller, based on a character or symbol displayed, lighting of a lamp, a change of light color or the like.

An electronic apparatus with a remote controller as set forth in a third aspect is the electronic apparatus with a remote controller as set forth in a first aspect, in which the residual battery capacity informing means indicates the residual battery capacity by a sound produced by an operating section of the electronic apparatus.

According to the configuration as set forth in a third aspect, since the residual battery capacity informing means indicates the residual battery capacity by a sound produced by an operating section of the electronic apparatus, the user can recognize the level of residual capacity of the battery in the remote controller, based on a sound, a melody, an alarm or the like.

An electronic apparatus with a remote controller as set forth in a fourth aspect is the electronic apparatus with a remote controller as set forth in a first aspect, in which a remote-controller manipulation key to be first or last pressed during use of the electronic apparatus is configured to function as a remote-controller manipulation key used for issuing an instruction to detect and inform of the residual battery capacity.

According to the configuration as set forth in a fourth aspect, since a remote-controller manipulation key to be first or last pressed during use of the electronic apparatus is configured to function as a remote-controller manipulation key used for issuing an instruction to detect and inform of the residual battery capacity, the user can recognize with reliability the residual battery capacity indicated by the electronic apparatus through visible or acoustic means. In addition, according to the prior-art technique, except when the user is manipulating the main unit, the remote controller may not be aimed at the main unit. In such a case, the main unit informs the user of the occurrence of an abnormality as in the case where no regular signal can reach the main unit, and thus, the user erroneously realizes that the main unit cannot be activated with the remote controller. According to the configuration as set forth in a fourth aspect, this problem can be avoided.

According to an implementation as set forth in a first aspect, in an electronic apparatus with a remote controller, since the remote controller comprises power supply means constituted by a battery, remote manipulation means that transmits an instruction signal corresponding to an instruction entered through manipulation of a manipulation key, thereby remotely manipulating the electronic apparatus, detection means that detects the voltage of the battery in the remote controller, and transmission means that converts the detected battery voltage into a code value and transmits the code value, and the transmission means converts the detected battery voltage into a code value, which is assigned to a classified level of voltage value of the detected battery voltage, the remote controller can transmit information about the current level of the detected battery voltage to the electronic apparatus in the form of a code value. In addition, since the electronic apparatus comprises code value converting means that converts the code value transmitted from the remote controller into a corresponding residual battery capacity value and residual battery capacity informing means that indicates the residual battery capacity converted from the code value by the code value converting means, the user can readily recognize the current level of residual capacity of the battery in the remote controller.

According to an implementation as set forth in a second aspect, in the electronic apparatus with the remote controller, since the residual battery capacity informing means visibly indicates the residual battery capacity on a display section of the electronic apparatus, the user can simply and readily recognize the level of residual capacity of the battery in the remote controller, based on a character or symbol displayed, lighting of a lamp, a change of light color or the like.

According to an implementation as set forth in a third aspect, in the electronic apparatus with the remote controller, since the residual battery capacity informing means indicates the residual battery capacity by a sound produced by an operating section of the electronic apparatus, the user can simply and readily recognize the level of residual capacity of the battery in the remote controller, based on a sound, a melody, an alarm or the like.

According to an implementation as set forth in a fourth aspect, in the electronic apparatus with the remote controller, since a remote-controller manipulation key to be first or last pressed during use of the electronic apparatus is configured to function as a remote-controller manipulation key used for issuing an instruction to detect and inform of the residual battery capacity, the user can recognize with reliability the residual battery capacity indicated by the electronic apparatus through visible means, such as a character or symbol displayed, lighting of a lamp, or a change of light color, or through acoustic means, such as a sound, a melody or an alarm. In addition, since detection and information of the residual battery capacity are carried out only when an instruction to activate or terminate the electronic apparatus is issued through manipulation of a remote-controller manipulation key, the battery can be prevented from being uselessly exhausted due to the regular signal transmission in the prior-art technique, and the life of battery can be extended.

### BRIEF DESCRIPTION OF THE DRAWINGS

FIG. 1 is a block diagram for illustrating an internal configuration of a remote controller for a television set according to a first embodiment of the present invention;

FIG. 2 is a table showing a relationship between key codes and key names for the remote controller according to the first embodiment of the present invention;

FIG. 3 is a table showing a relationship between classified levels of residual battery capacity and exemplary indications thereof for the remote controller according to the first embodiment of the present invention;

FIG. 4 is a flowchart showing an operation of the remote controller when a POWER key is pressed down according to the first embodiment of the present invention;

FIG. 5 is a flowchart showing a POWER-ON operation of the television set when the television set receives a POWER key code according to the first embodiment of the present invention;

FIG. 6 is a block diagram for illustrating an internal configuration of a remote controller for an automobile according to a second embodiment of the present invention;

FIG. 7 is a table showing a relationship between key codes and key names for the remote controller according to the second embodiment of the present invention;

FIG. 8 is a table showing a relationship between classified levels of residual battery capacity and exemplary indications thereof for the remote controller according to the second embodiment of the present invention;

FIG. 9 is a block diagram for illustrating an internal configuration of a remote controller for a light fixture according to a third embodiment of the present invention;

FIG. 10 is a table showing a relationship between key codes and key names for the remote controller according to the third embodiment of the present invention; and

FIG. 11 is a table showing a relationship between classified levels of residual battery capacity and exemplary indications thereof for the remote controller according to the third embodiment of the present invention.

### DETAILED DESCRIPTION OF THE PREFERRED EMBODIMENTS

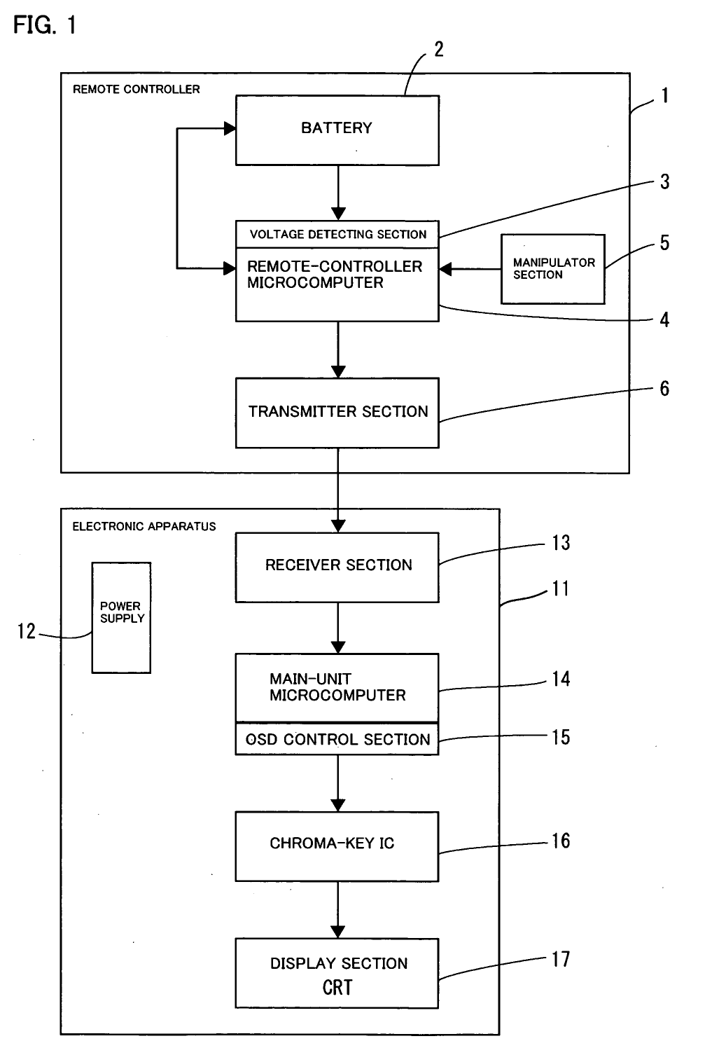

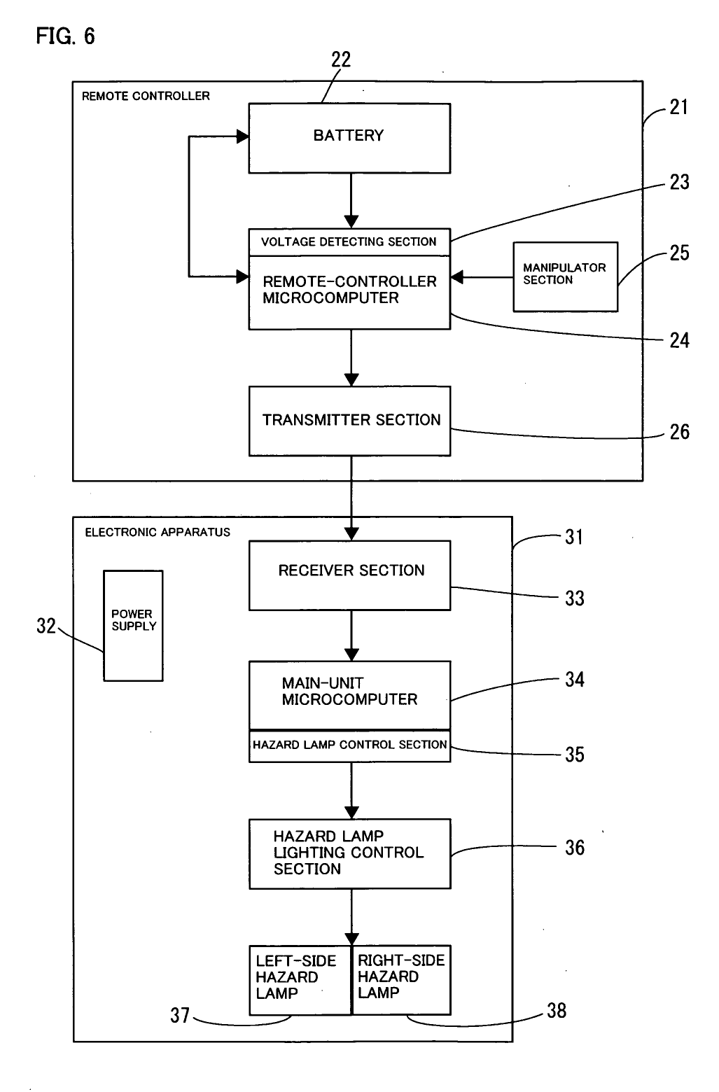

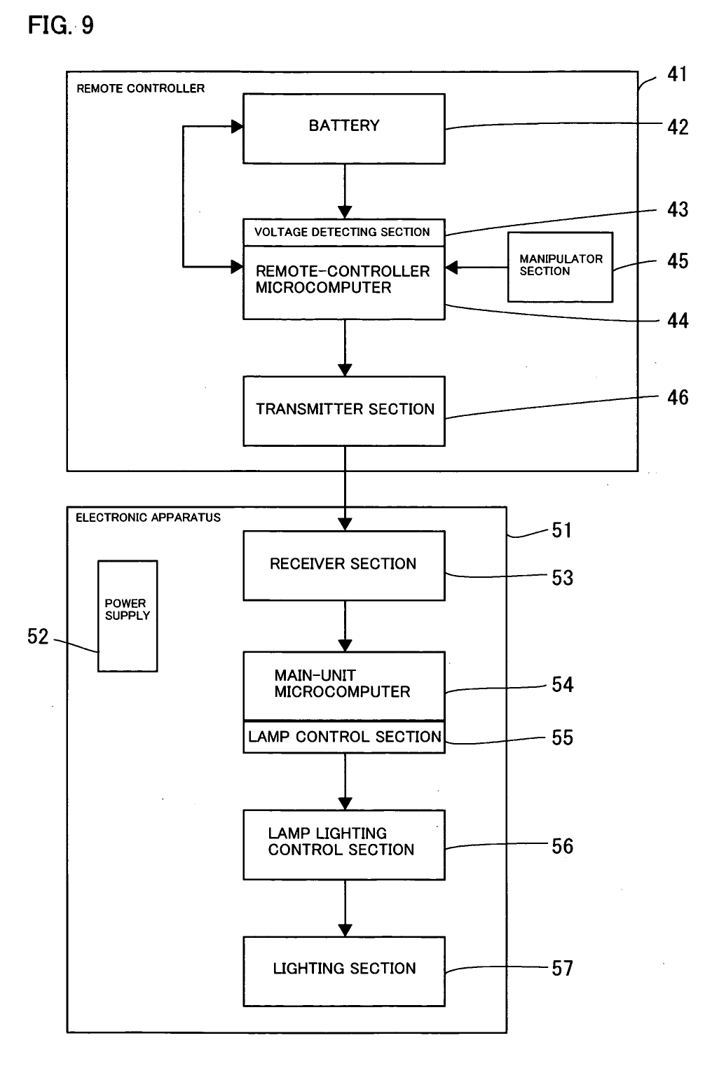

In the following, as best modes for carrying out the present invention, embodiments thereof will be described with reference to FIGS. 1 to 11. FIGS. 1 to 5 are diagrams for illustrating a remote controller for a television set according to a first embodiment of the present invention. FIGS. 6 to 8 are diagrams for illustrating a remote controller for an automobile according to a second embodiment of the present invention. FIGS. 9 to 11 are diagrams for illustrating a remote controller for a light fixture according to a third embodiment of the present invention. Of course, the present invention is not limited to the embodiments described below and has many other applications without departing from the scope and spirit thereof.

### Embodiment 1

First, with reference to a block diagram of FIG. 1, an internal configuration of a remote controller 1 for a television set and a television set 11 according to a first embodiment of the present invention will be described. The remote controller 1 contains two 1.5-volt batteries 2, which are connected in series to constitute a 3-volt power supply. In addition, the remote controller 1 comprises a voltage detecting section 3 that detects the voltage of the batteries 2, a remote-controller microcomputer 4 that converts the detected voltage value into a code value, which is assigned to a classified level of voltage value that corresponds to the detected voltage value, a manipulator section 5 having an array of remote-controller manipulation keys for remotely manipulating the television set 11, and a transmitter section 6 that transmits the code value to the television set 11. The television set 11 comprises a receiver section 13 that receives the code value signal transmitted from the transmitter section 6, a main-unit microcomputer 14 that converts the received code value signal into information about the residual battery capacity corresponding to the code value, an on-screen-display (OSD) controller section 15 that performs a processing for showing the information about the residual battery capacity on a display screen in an overlaid manner, a chroma-key IC 16 that superimposes an image in the display screen and the information about the residual battery capacity converted from the code value on another display screen, a display section 17 for providing an indication of the residual battery capacity constituted by a cathode-ray tube (CRT) or a liquid crystal display (LCD), and a power supply circuit section 12 that supplies electric power to all the components of the television set 11 including those described above.

Now, the voltage detecting section 3 that detects the voltage of the batteries in the remote controller 1 will be described. The remote controller 1 for a television set uses two 1.5-volt batteries connected in series, which constitute a 3-volt power supply. It is provided that, when a use presses down a POWER button (not shown) in the remote-controller manipulator section 5 to turn on the television set 11, and when the user presses down the POWER button to turn off the television set 11, the battery voltage is detected in the remote controller 1, and the display section 17 in the television set 11 provides an indication of the residual battery capacity. According to the present invention, an AD terminal (not shown) of the remote-controller microcomputer 4 converts the input analog voltage to a digital voltage, thereby determining the input voltage with respect to a reference voltage. Alternatively, however, a voltage detecting IC (not shown) may be used to detect the voltage, or a voltage detecting circuit (not shown) may be provided to detect the voltage.

Now, there will be described an operation of converting the detected battery voltage into a code value assigned to a classified level of voltage value corresponding to the detected voltage. The remote-controller microcomputer 4 incorporates a reset IC (not shown), and voltage detection is started when the POWER key (not shown) is pressed down. The range of voltage in which the remote-controller microcomputer 4 can normally operate, that is, the range of voltage down to the lower limit where the remote-controller microcomputer 4 is reset by the reset IC, is divided into a plurality of classes, and different key codes, each of which corresponds to one of the classified levels, are assigned to the one key. That is, the one key is assigned with a plurality of key codes.

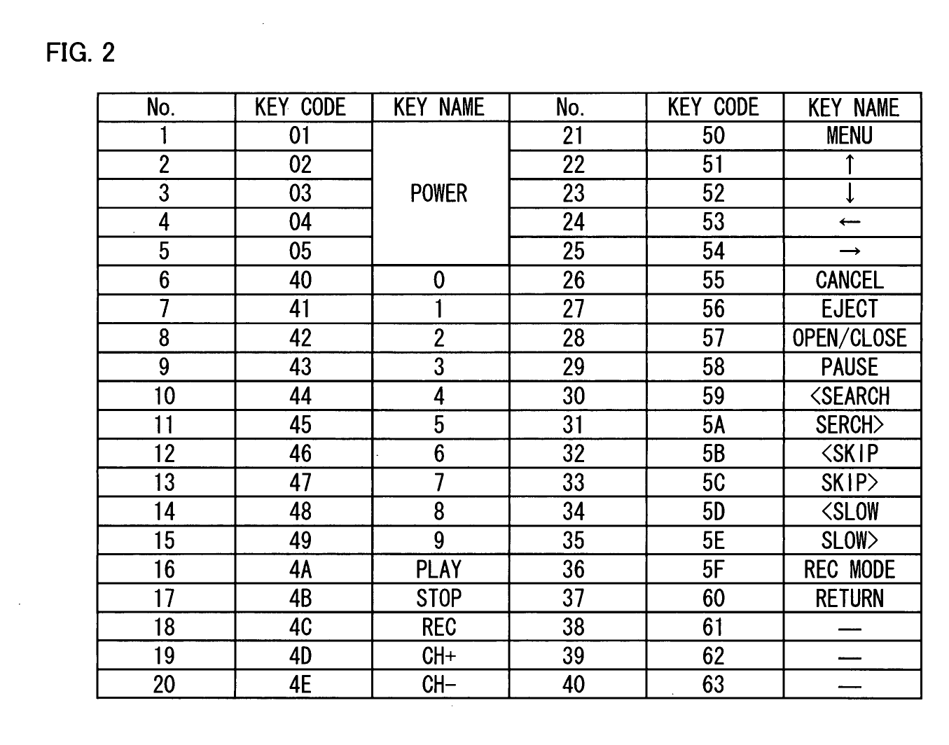

More specifically, as shown in FIG. 2, the remote-controller manipulation keys 5 of the remote controller 1 are each assigned with a key code and a key name. Here, a key name of “POWER” will be described. The key name “POWER” corresponds to the POWER key of the remote-controller manipulation keys 5, and as described above, a plurality of key codes 01 to 05 are assigned to the one POWER key. Each of the key codes 01 to 05 corresponds to one of the classified levels of voltage value. Furthermore, the POWER key serves also as a remote-controller manipulation key 5 that is pressed down to issue an instruction to turn on or off the television set.

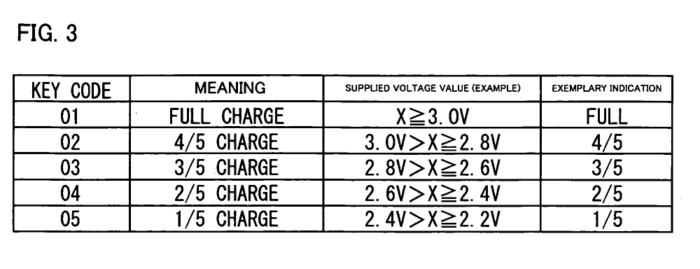

Now, with reference to FIG. 3, there will be described meanings of the key codes 01 to 05 assigned to the classified levels of battery voltage value and a method of informing of the residual battery capacity on the display section 17 of the television set 11. The key codes 01 to 05 are classified as “FULL CHARGE”, “⅘ CHARGE”, “⅗ CHARGE”, “⅖ CHARGE” and “⅕ CHARGE”, respectively, according to the level of battery voltage. If the battery voltage supplied to the remote controller 1 and detected by the AD terminals of the remote-controller microcomputer 4, which are the voltage detecting section 3, is equal to or higher than 3.0 v, the battery voltage corresponds to “FULL CHARGE”, and “FULL” is displayed on the display screen. If the battery voltage is lower than 3.0 v and equal to or higher than 2.8 v, it corresponds to “⅘ CHARGE”, and “⅘” is displayed on the display screen. If the battery voltage is lower than 2.8 v and equal to or higher than 2.6 v, it corresponds to “⅗ CHARGE”, and “⅗” is displayed on the display screen. If the battery voltage is lower than 2.6 v and equal to or higher than 2.4 v, it corresponds to “⅖ CHARGE”, and “⅖” is displayed on the display screen. If the battery voltage is lower than 2.4 v and equal to or higher than 2.2 v, it corresponds to “⅕ CHARGE”, and “⅕” is displayed on the display screen. If the battery voltage is lower than 2.2 v, the residual battery capacity informing means of the remote controller 1 does not operate.

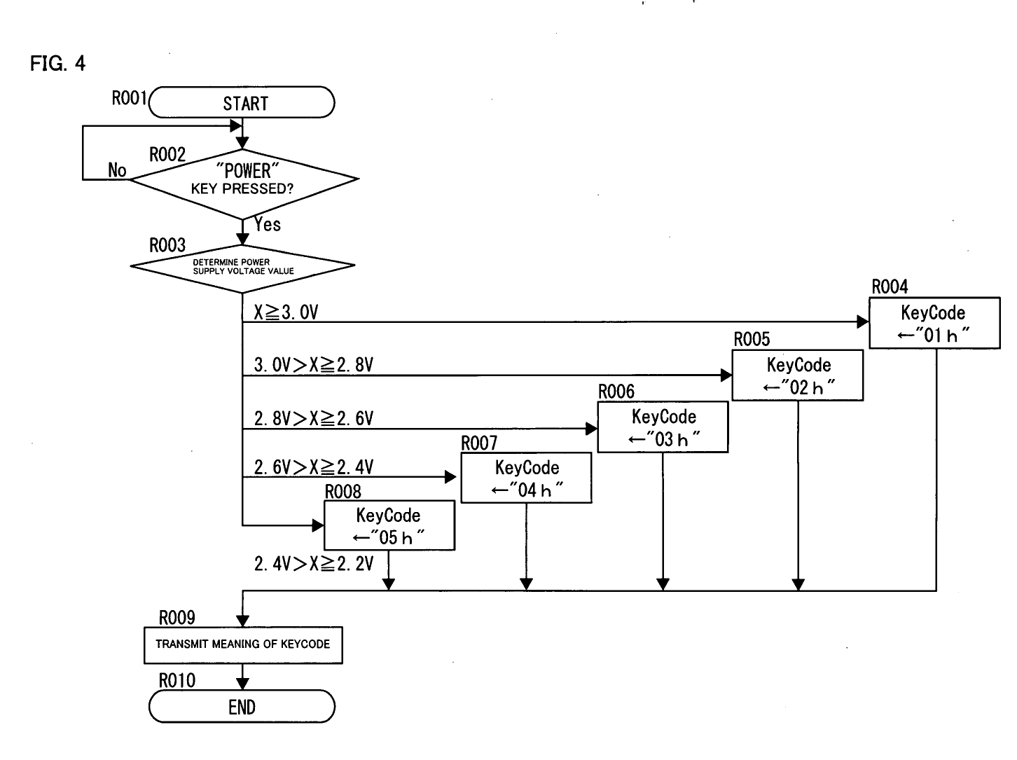

Now, with reference to FIG. 4, a flow of an operation of the remote controller when the POWER key is pressed down will be described. In step R001, the POWER key is pressed down. In step R002, the remote-controller microcomputer 4 confirms whether the POWER key is pressed down or not, and if the result is “NO”, the process does not continue to any next step. If the result is “YES”, the voltage detecting section 3 starts detecting the voltage and determines the range of voltage in which the microcomputer normally operates. Then, in step R003, the power supply voltage is determined. If the battery voltage is 2.7 v, a key code “03h” is assigned in step R004, and the key code “03h” is transmitted to the television set 11, the associated electronic apparatus, in step R009. Then, in step R010, the process is ended.

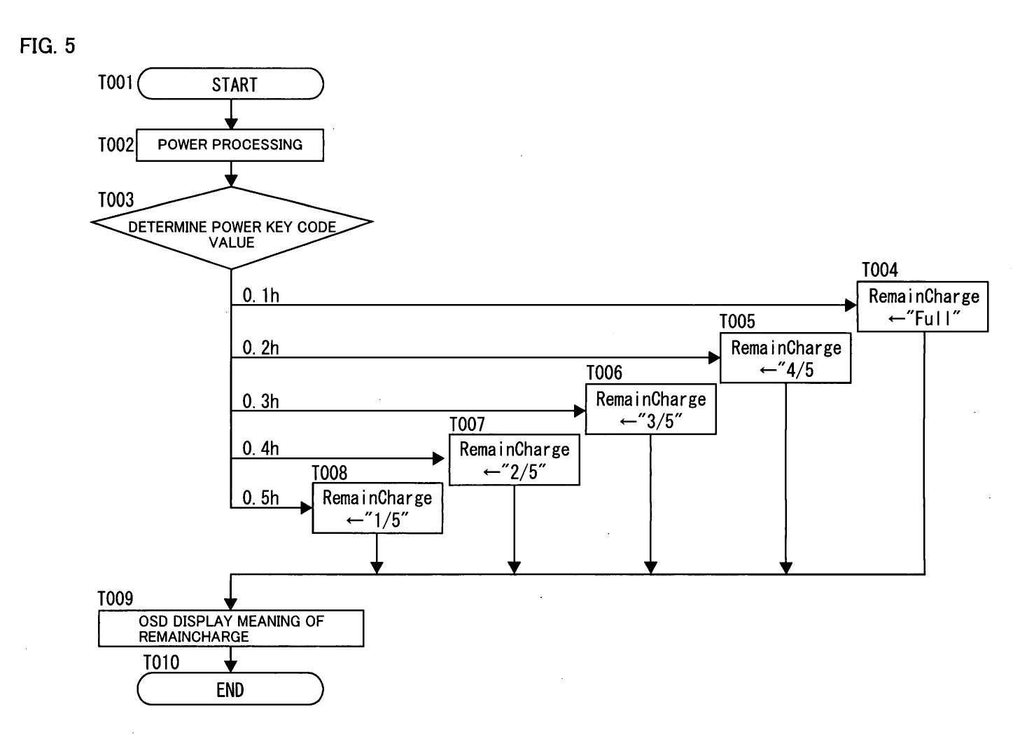

Now, with reference to FIG. 5, a flow of an operation of the television set 11 will be described. In step T001, the user presses down the POWER key to issue an instruction to turn on the television set 11. Then, the television set 11 receives the turn-on instruction from the remote controller and starts showing received images in step T002. Then, in step T003, the received key code “03h” corresponding to the battery voltage of the remote controller 1 is fed from the receiver section 13 to the main-unit microcomputer 14, and the main-unit microcomputer 14 identifies the key code as “03h” by means of a program that performs stepwise switching of key codes. Then, in step T006, based on the table shown in FIG. 3, the main-unit microcomputer 14 issues an instruction to display “⅗” to the OSD control section 15. Then, in step T009, the OSD control section 15 performs a processing to enable the indication “⅗” to be displayed on the screen in an overlaid manner, the chroma-key IC 16 combines the indication “⅗” with the received images, and the display section 17 provides the indication “⅗” as the residual battery capacity of the remote controller. Then, in step T010, the operation is ended.

### Embodiment 2

Now, with reference to a block diagram of FIG. 6, there will be described a remote controller 21 for locking/unlocking automobile doors and a door locking/unlocking electronic apparatus 31 mounted on an automobile according to a second embodiment of the present invention. The remote controller 21 uses a 3-volt button type battery 22 as a power supply and comprises a voltage detecting section 23 that detects the voltage of the battery 22, a remote-controller microcomputer 24 that converts the detected voltage into a code value, which is assigned to a classified level of voltage value of the battery 22, a manipulator section 25 having an array of remote-controller manipulation keys 25 for remotely manipulating the door locking/unlocking electronic apparatus 31 on an automobile, and a transmitter section 26 that transmits the code value to the electronic apparatus 31. On the other hand, the electronic apparatus 31 comprises a receiver section 33 that receives the code value signal transmitted from the transmitter section 26, a main-unit microcomputer 34 that converts the received code value into information about the corresponding residual battery capacity, a hazard lamp control section 35 that controls the flashing of a hazard lamp (not shown) of the automobile so as to indicate the residual battery capacity, a hazard lighting control section 36, a left-side hazard lamp 37 disposed on the left side of the automobile body, a right-side hazard lamp 38, and a power supply section 32 that supplies electric power to all the parts of the automobile including those described above.

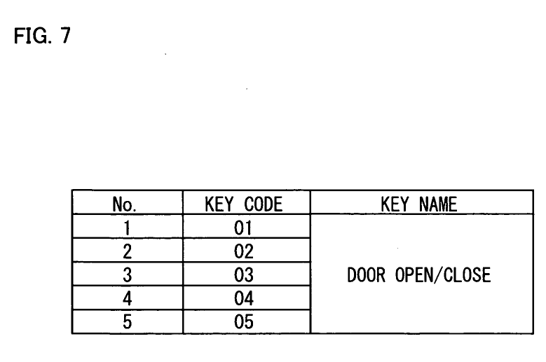

Now, description will be made with reference to FIG. 7. The remote-controller manipulation keys 25 of the remote controller 21 are each assigned with a key code and a key name. As with the remote controller 1 for the television set 1, a key name of “DOOR OPEN/CLOSE” corresponds to a DOOR OPEN/CLOSE key of the remote-controller manipulation keys 5, and as described above, a plurality of key codes 01 to 05 are assigned to the one DOOR OPEN/CLOSE key. Each of the key codes 01 to 05 corresponds to one of the classified levels of voltage value. Furthermore, the DOOR OPEN/CLOSE remote-controller manipulation key 25 serves also as a remote-controller manipulation key 25 that is pressed down to issue an instruction to lock or unlock automobile doors.

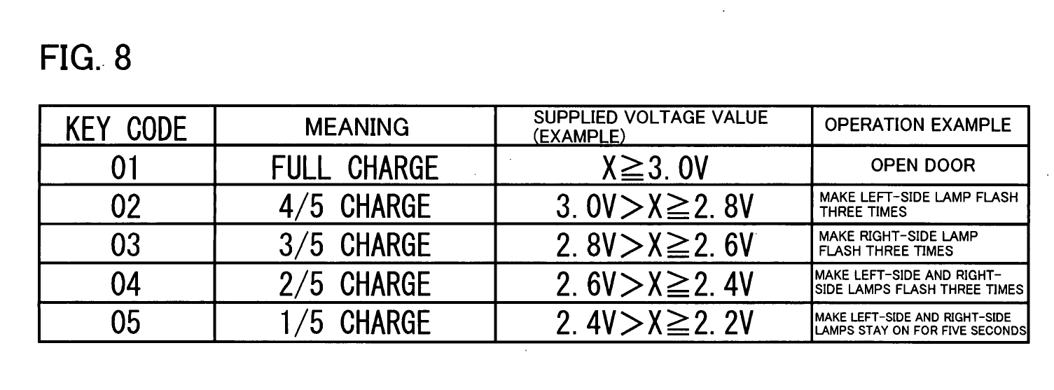

Now, with reference to FIG. 8, there will be described meanings of the key codes 01 to 05 assigned to the classified levels of battery voltage value and a method of informing of the residual battery capacity of the remote controller 21 for an automobile. According to this embodiment, information of the residual battery capacity is carried out when the remote-controller manipulation key 25 for issuing an instruction to unlock automobile doors is manipulated. The key codes 01 to 05 are classified as “FULL CHARGE”, “⅘ CHARGE”, “⅗ CHARGE”, “⅖ CHARGE” and “⅕ CHARGE”, respectively, according to the level of battery voltage. If the battery voltage supplied to the remote controller 21 and detected by the AD terminals of the remote-controller microcomputer 24, which are the voltage detecting section 23, is equal to or higher than 3.0 v, the battery voltage corresponds to “FULL CHARGE”, and the automobile doors are opened. If the battery voltage is lower than 3.0 v and equal to or higher than 2.8 v, it corresponds to “⅘ CHARGE”, and the left-side hazard lamp flashes three times. If the battery voltage is lower than 2.8 v and equal to or higher than 2.6 v, it corresponds to “⅗ CHARGE”, and the right-side hazard lamp flashes three times. If the battery voltage is lower than 2.6 v and equal to or higher than 2.4 v, it corresponds to “⅖ CHARGE”, and the left-side and right-side hazard lamps flash three times. If the battery voltage is lower than 2.4 v and equal to or higher than 2.2 v, it corresponds to “⅕ CHARGE”, and the left-side and right-side hazard lamps stay on for five seconds. If the battery voltage is lower than 2.2 v, the residual battery capacity informing means of the remote controller 21 does not operate.

### Embodiment 3

Now, with reference to a block diagram of FIG. 9, there will be described a light controlling remote controller provided for a light fixture according to a third embodiment of the present invention. A remote controller 41 contains two 1.5-volt batteries 42 connected in series to form a 3-volt power supply. The remote controller 41 comprises a voltage detecting section 43 that detects the voltage of the batteries 42, a remote-controller microcomputer 44 that converts the detected voltage into a code value, which is assigned to a classified level of voltage value of the batteries 42, a manipulator section 45 having an array of remote-controller manipulation keys 45 for remotely manipulating a light controlling electronic apparatus 51 of the light fixture, and a transmitter section 46 that transmits the code value to the electronic apparatus 51. On the other hand, the light controlling electronic apparatus 51 comprises a receiver section 53 that receives the code value signal transmitted from the transmitter section 46, a main-unit microcomputer 54 that converts the received code value into information about the corresponding residual battery capacity, a lamp control section 55 that controls the light controlling electronic apparatus 51 of the light fixture to make the light fixture flash so as to indicate the residual battery capacity, a lamp lighting control section 56, a lighting section 57 for the light fixture, and a power supply section 52 that supplies electric power to all the parts of the light fixture including those described above.

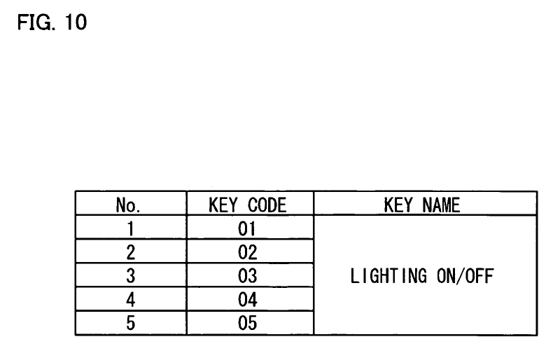

Now, key codes for the light controlling remote controller 41 for the light fixture will be described with reference to FIG. 10. The remote controller 41 is configured to detect the residual battery capacity and inform of the same when the light fixture is turned on. The remote-controller manipulation keys 45 of the remote controller 41 are each assigned with a key code and a key name. As with the remote controller 1 for the television set 1 described above, a key name of “LIGHTING ON/OFF” corresponds to a LIGHTING ON/OFF key of the remote-controller manipulation keys 45, and as described above, a plurality of key codes 01 to 05 are assigned to the one LIGHTING ON/OFF key. Each of the key codes 01 to 05 corresponds to one of the classified levels of voltage value. Furthermore, the LIGHTING ON/OFF remote-controller manipulation key 45 serves also as a remote-controller manipulation key 45 that is pressed down to issue an instruction to turn on the light fixture or control the light thereof.

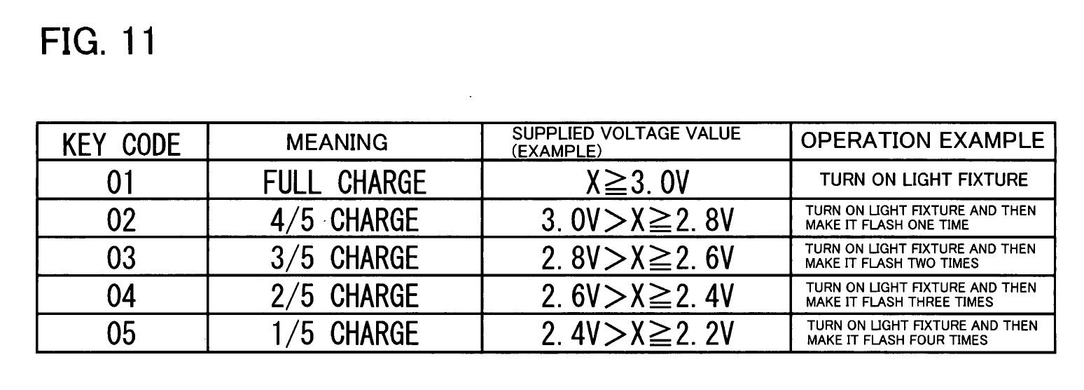

Now, with reference to FIG. 11, there will be described meanings of the key codes 01 to 05 assigned to the classified levels of battery voltage value and a method of informing of the residual battery capacity of the remote controller 41 for a light fixture. The key codes 01 to 05 are classified as “FULL CHARGE”, “⅘ CHARGE”, “⅗ CHARGE”, “⅖ CHARGE” and “⅕ CHARGE”, respectively, according to the level of battery voltage. If the battery voltage supplied to the remote controller 21 and detected by the AD terminals of the remote-controller microcomputer 24, which are the voltage detecting section 23, is equal to or higher than 3.0 v, the battery voltage corresponds to “FULL CHARGE”, and the light fixture is turned on. If the battery voltage is lower than 3.0 v and equal to or higher than 2.8 v, it corresponds to “⅘ CHARGE”, and the light fixture is turned on and then flashes one time. If the battery voltage is lower than 2.8 v and equal to or higher than 2.6 v, it corresponds to “⅗ CHARGE”, and the light fixture is turned on and then flashes two times. If the battery voltage is lower than 2.6 v and equal to or higher than 2.4 v, it corresponds to “⅖ CHARGE”, and the light fixture is turned on and then flashes three times. If the battery voltage is lower than 2.4 v and equal to or higher than 2.2 v, it corresponds to “⅕ CHARGE”, and the light fixture is turned on and then flashes four times. If the battery voltage is lower than 2.2 v, the residual battery capacity informing means of the remote controller 41 does not operate.

As described above, the electronic apparatus provided with the remote controller according to the present invention may be the television set 11 provided with the remote controller 1, the electronic apparatus 31 for locking or unlocking automobile doors that is provided with the remote controller 21, or the light controlling electronic apparatus 51 for a light fixture provided with the remote controller 41. In addition, the electronic apparatus provided with the remote controller according to the present invention has many other applications, such as an industrial apparatus. For example, in the case of the television set 11, the residual capacity of the battery 2 used in the remoter controller 1 is classified into plural levels, the remote controller 1 transmits a classified level of residual capacity of the battery 2 to the electronic apparatus 11, and the informing means in the electronic apparatus 11 enables the user to recognize the level of residual capacity of the battery 2. In addition, detection and information of the residual capacity are carried out when the remote-controller manipulation key 5 is first or last manipulated during use of the electronic apparatus 11. Thus, unlike the prior-art technique, the battery can be prevented from being exhausted quickly due to the regular signal transmission, and the user can be informed of the residual battery capacity with reliability when the electronic apparatus 11 is turned on or off. Thus, the user can simply and readily recognize the current level of residual battery capacity of the battery 2 in the remote controller 1. In addition, the informing means indicates the residual battery capacity in a visible manner, such as by displaying predetermined characters on the display section 17 of the television set 11, making the hazard lamps of the automobile flash in a predetermined manner, or making the light fixture flash in a predetermined manner. Thus, the user can readily recognize the level of residual battery capacity of the battery 2 in the remote controller 1, based on the displayed characters or symbols, flashing of the lamp, a change of light color, or the like. As an alternative to the visibly informing means, a speaker or the like may be used to provide acoustic information, and in such a case, the user can recognize the residual battery capacity by a sound, a melody, an alarm or the like. In addition, detection and information of the residual battery capacity are carried out when the electronic apparatus 11 is first or last manipulated by means of the remote controller 1, that is, when the user is manipulating the remote-controller manipulation key 5 to issue an activation instruction or stop instruction to the electronic apparatus 11. Therefore, the user is looking at the electronic apparatus at that moment, so that the user is hard to miss the information from the informing means. Thus, the user can recognize, with reliability, the residual battery capacity based on the characters or symbols, flashing of the lamp, a change of light color or the like provided by the electronic apparatus 11, or a sound, a melody, an alarm or other acoustic means. Furthermore, the detection and information of the residual battery capacity are carried out only when an activation instruction or stop instruction is issued to the electronic apparatus 11 through manipulation of the remote-controller manipulation key 5. Therefore, unlike the prior-art technique, the battery can be prevented from being exhausted uselessly due to the regular signal transmission, and the life of the battery can be extended.

While embodiments of the present invention have been described above in detail, the present invention is not limited thereto, and various modifications are possible without departing from the scope and spirit of the present invention. For example, the remote controller 1 capable of informing of the residual battery capacity can be applied not only to consumer apparatus, such as a television set, an automobile and a light fixture, but also to a wide variety of industrial apparatus as described above. In addition, the remote controller 1 may not have a function of informing of the residual battery capacity, and it is essential only that the electronic apparatus that can be remotely controlled with the remote controller has a capability of informing of the residual battery capacity by means of sound, light or the like. Furthermore, the informing means can provide indications not only through a sound, light, and image or the like but also through vibration. Furthermore, the number of levels of battery voltage classified by the remote controller 1 may not necessarily be five in the embodiments described above, and can vary for convenience of use and be appropriately chosen.

What is claimed is:

1. An electronic apparatus with a remote controller, the remote controller including power supply means constituted by a battery, remote manipulation means that transmits an instruction signal corresponding to an instruction entered through manipulation of a manipulation key, thereby remotely manipulating the electronic apparatus, detection means that detects the voltage of the battery, and transmission means that converts the detected battery voltage into a code value and transmits the code value, wherein the transmission means converts the detected battery voltage into a code value, which is assigned to a classified level of voltage value of the detected battery voltage, and the electronic apparatus comprises code value converting means that converts the code value transmitted from the remote controller into a corresponding residual battery capacity value and residual battery capacity informing means that indicates the residual battery capacity converted from the code value by the code value converting means.

2. The electronic apparatus with a remote controller according to claim 1, wherein the residual battery capacity informing means visibly indicates the residual battery capacity on a display section of the electronic apparatus.

3. The electronic apparatus with a remote controller according to claim 1, wherein the residual battery capacity informing means indicates the residual battery capacity by a sound produced by an operating section of the electronic apparatus.

4. The electronic apparatus with a remote controller according to claim 1, wherein a remote-controller manipulation key to be first or last pressed during use of the electronic apparatus is configured to function as a remote-controller manipulation key used for issuing an instruction to detect and inform of the residual battery capacity.
